(19) United States
(12) Patent Application Publication
(10) Pub. No.: US 2023/0286135 A1
(43) Pub. Date: Sep. 14, 2023

(54) VEHICLE DOOR REMOVAL DEVICE AND VEHICLE DOOR REMOVAL METHOD

(71) Applicant: Honda Motor Co., Ltd., Tokyo (JP)

(72) Inventors: Yoshinao SHIGEHARA, Tokyo (JP); XianCai WANG, Guangzhou (CN); Tomohiro SUGIMOTO, Tokyo (JP)

(73) Assignee: Honda Motor Co., Ltd., Tokyo (JP)

(21) Appl. No.: 18/169,860

(22) Filed: Feb. 15, 2023

(30) Foreign Application Priority Data
Mar. 8, 2022 (CN) 202210227478.2

(51) Int. Cl. B25J 9/00; B25J 15/00

(52) U.S. Cl. CPC B25J 9/0084; B25J 15/0047

(57) ABSTRACT

The disclosure provides a vehicle door removal device and a vehicle door removal method. The vehicle door removal device is adapted to remove a vehicle door from a vehicle body of a vehicle and includes a first robot arm on an outer side of the vehicle door; a first jig disposed on the first robot arm and having an engaging part for engaging an opening part on a window frame of the vehicle and a pair of clamping parts for clamping the vehicle in an up-and-down direction of the vehicle; a second robot arm near the first robot arm; a second jig disposed on the second robot arm and having a fastening member releasing part for releasing a fastening member fastened on the vehicle body and the vehicle door and a connecting part for connecting an inner side of the vehicle door.

### CROSS-REFERENCE TO RELATED APPLICATION

This application claims the priority benefit of Chinese application no. 202210227478.2, filed on Mar. 8, 2022. The entity of the above-mentioned patent application is hereby incorporated by reference herein and made a part of this specification.

### BACKGROUND

### Technical Field

The disclosure relates to a vehicle door removal device and a vehicle door removal method.

### Description of Related Art

According to the related art, in a process of removing a vehicle door installed on a vehicle body by applying a robot arm and a jig disposed on the robot arm, both robot arms of a double-arm robot may serve to perform different actions (such as opening the vehicle door, releasing a fastening member, and so on). For instance, Japanese Unexamined Patent Application Publication No. 2012-140024 discloses a door opening method and a device which can reduce an installation area of a robot and can shorten a cycle time, where two arms of a two-arm robot are rotated on an S1 axis and an S2 axis, respectively. However, when both robot arms perform operations on an inner side of the vehicle door in an open state, whether the motions of the two robot arms interfere with each other should be taken into account, thus resulting in restrictions to moving traces of the two robot arms. Besides, an increasing design cost of planning moving paths may be expected.

### SUMMARY

The disclosure provides a vehicle door removal device adapted to remove a vehicle door from a vehicle body of a vehicle. The vehicle door removal device includes: a first robot arm disposed on an outer side of the vehicle door; a first jig disposed on the first robot arm and having an engaging part for engaging an opening part on a window frame of the vehicle and a pair of upper and lower clamping parts for clamping the vehicle door in an up-and-down direction of the vehicle; a second robot arm disposed near the first robot arm; and a second jig disposed on the second robot arm and having a fastening member releasing part for releasing a fastening member fastened on the vehicle body and the vehicle door and a connecting part for connecting an inner side of the vehicle door, where the first robot arm located on the outer side of the vehicle door in an open state performs an operation of the first jig, and the second robot arm located on the inner side of the vehicle door in the open state performs an operation of the second jig.

In an embodiment of the disclosure, the engaging part of the first jig is disposed on the upper clamping part of the pair of upper and lower clamping parts and located on a portion of the upper clamping part close to a backward direction of the vehicle.

In an embodiment of the disclosure, the connecting part of the second jig includes a plurality of protruding parts, and the connecting part of the second jig connects the inner side of the vehicle door by inserting the protruding parts respectively into a plurality of opening parts disposed on the inner side of the vehicle door.

In an embodiment of the disclosure, the protruding parts include at least one fixed protruding part and at least one movable protruding part, and the at least movable protruding part moves relative to the at least one fixed protruding part to adjust a distance between the at least one movable protruding part and the at least one fixed protruding part.

The disclosure further provides a vehicle door removal method adapted to remove a vehicle door from a vehicle body of a vehicle. The vehicle door removal method includes: an engaging step of engaging an opening part on a window frame of the vehicle door through an engaging part of a first jig disposed on a first robot arm; an opening step of opening the vehicle door in an outward manner through the first robot arm which moves relative to the vehicle body; a clamping step of clamping the vehicle door in an up-and-down direction of the vehicle by moving a pair of upper and lower clamping parts of the first jig disposed on the first robot arm up and down; a fastening member releasing step of releasing a fastening member fastened on the vehicle body and the vehicle door through a fastening member releasing part of a second jig disposed on a second robot arm; a connecting step of conveying the vehicle door in an outward manner through the second robot arm moving in an outward manner relative to the vehicle body, where the first robot arm located on an outer side of the vehicle door in an open state performs an operation of the first jig, and the second robot arm located on the inner side of the vehicle door in the open state performs an operation of the second jig.

In an embodiment of the disclosure, after the connecting part of the second jig connects the inner side of the vehicle door in the connecting step, the pair of the upper and lower clamping parts of the first jig is released, and the conveyance step is performed on a condition that the connecting part of the second jig connects the vehicle door.

In an embodiment of the disclosure, the connecting part of the second jig includes a plurality of protruding parts, and in the connecting step, the connecting part of the second jig connects the inner side of the vehicle door by inserting the plurality of protruding parts respectively into a plurality of opening parts disposed on the inner side of the vehicle door.

In an embodiment of the disclosure, the protruding parts include at least one fixed protruding part and at least one movable protruding part, and in the connecting step, the at least one movable protruding part moves relative to the at least one fixed protruding part to adjust a distance between the at least one movable protruding part and the at least one fixed protruding part.

To make the above-mentioned features of the disclosure more understandable, embodiments are provided hereinafter with the accompanying drawings and detailed descriptions.

### BRIEF DESCRIPTION OF THE DRAWINGS

FIG. 1 is a schematic three-dimensional view of a vehicle door removal device according to an embodiment of the disclosure.

FIG. 2 is a schematic three-dimensional view of a first jig used by the vehicle door removal device depicted in FIG. 1.

FIG. 3 is a schematic three-dimensional view of a second jig used by the vehicle door removal device depicted in FIG. 1.

FIG. 4A to FIG. 4F are schematic flowcharts of operations of the vehicle door removal device depicted in FIG. 1 in a vehicle door removal method.

FIG. 5 is a schematic flowchart of a vehicle door removal method according to an embodiment of the disclosure.

### DESCRIPTION OF THE EMBODIMENTS

The disclosure is directed to a vehicle door removal device and a vehicle door removal method, which may prevent interferences of moving traces of a plurality of robot arms and further improve the degree of freedom of a motion of removing the vehicle door.

In view of the above, in the vehicle door removal device and the vehicle door removal method provided in one or more embodiments of the disclosure, the engaging part of the first jig disposed on the first robot arm is engaged with the opening part on the window frame of the vehicle door to open the vehicle door in an outward manner. The pair of upper and lower clamping parts of the first jig clamps the vehicle door in an up-and-down direction of the vehicle. The fastening member releasing part of the second jig disposed on the second robot arm releases the fastening member fastened on the vehicle body and the vehicle door. The connecting part of the second jig connects the inner side of the vehicle door to convey the vehicle door in an outward manner. Thereby, the first robot arm located on the outer side of the vehicle door in the open state performs the operation of the first jig, and the second robot arm located on the inner side of the vehicle door in the open state performs the operation of the second jig. Accordingly, the vehicle door removal device and the vehicle door removal method provided in one or more embodiments of the disclosure may prevent the moving traces of the robot arms from interfering with each other, thereby improving the degree of freedom of the motion of removing the vehicle door.

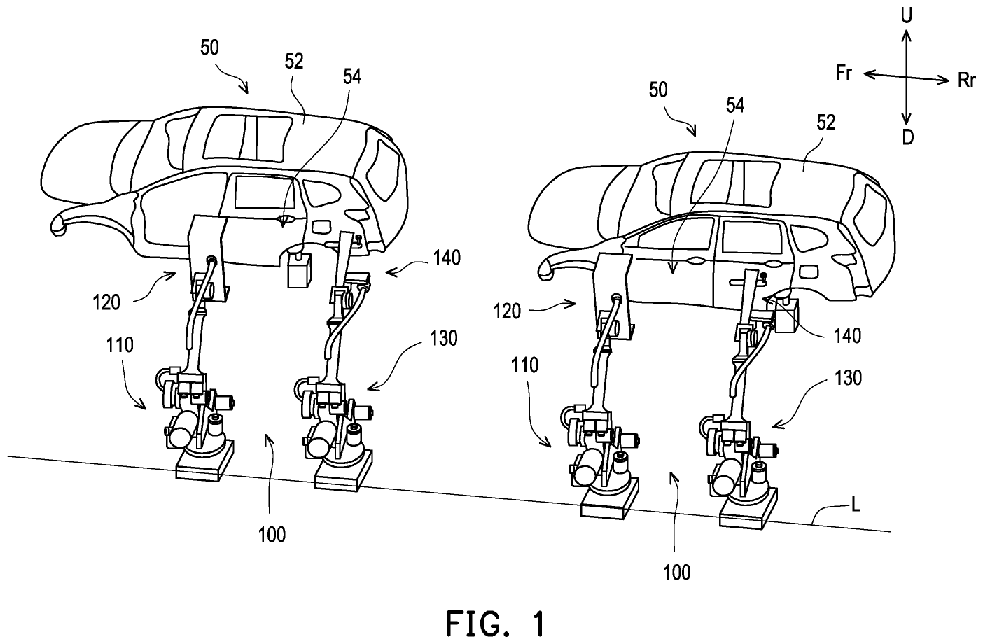

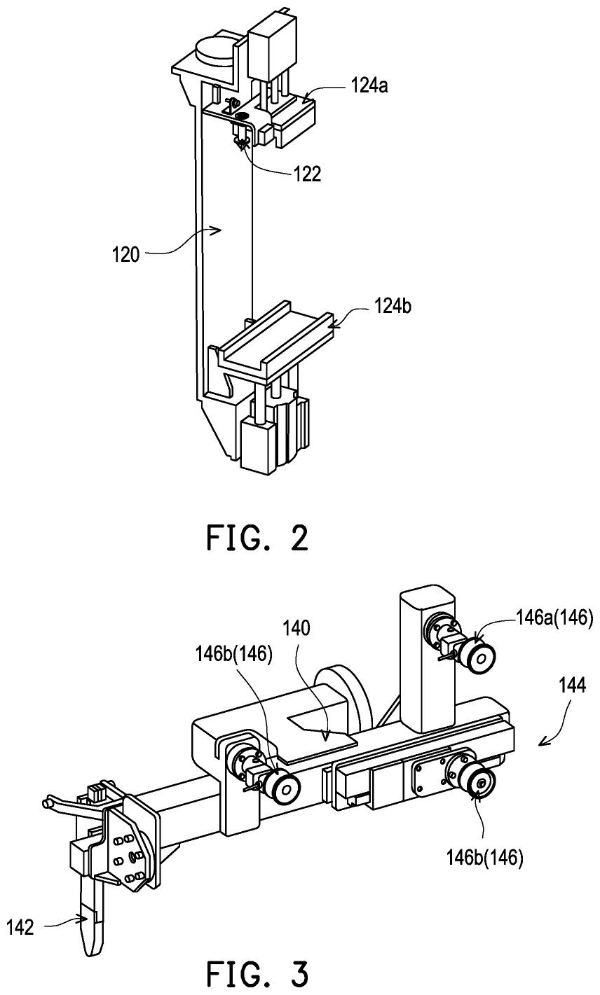

Reference will now be made in detail to the exemplary embodiments of the disclosure, examples of which are illustrated in the accompanying drawings. Wherever possible, the same reference numerals are used in the drawings and description to refer to the same or like parts. Here, FIG. 1 is a schematic three-dimensional view of a vehicle door removal device according to an embodiment of the disclosure; FIG. 2 is a schematic three-dimensional view of a first jig used by the vehicle door removal device depicted in FIG. 1; FIG. 3 is a schematic three-dimensional view of a second jig used by the vehicle door removal device depicted in FIG. 1;

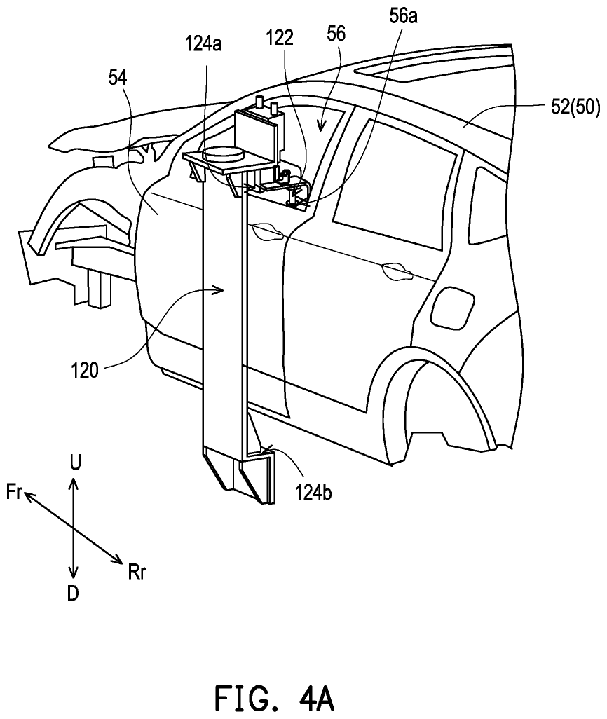

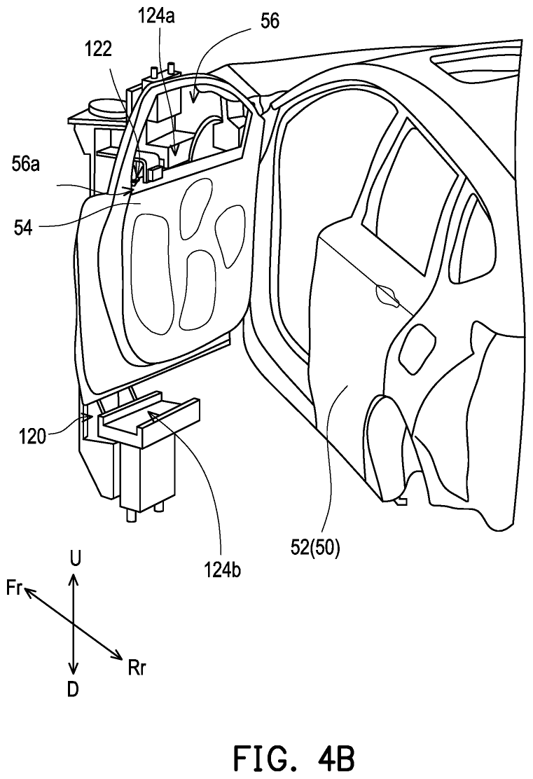

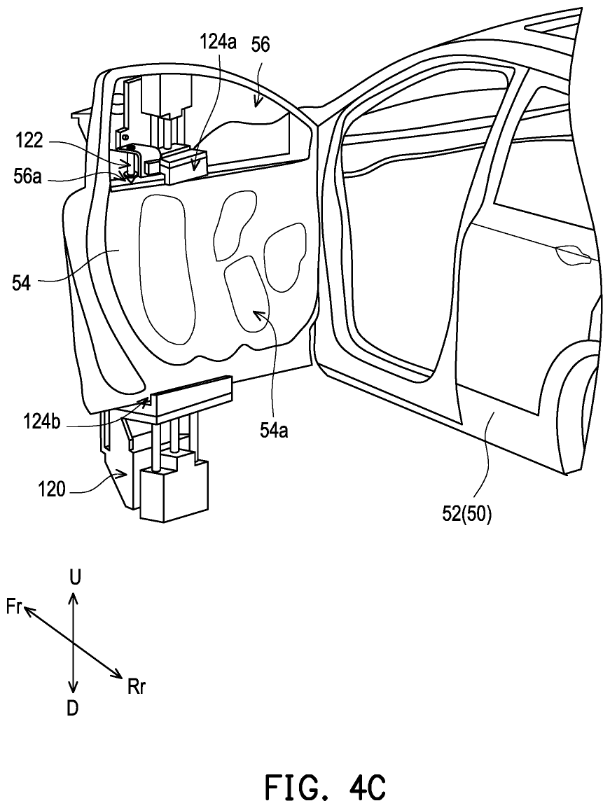

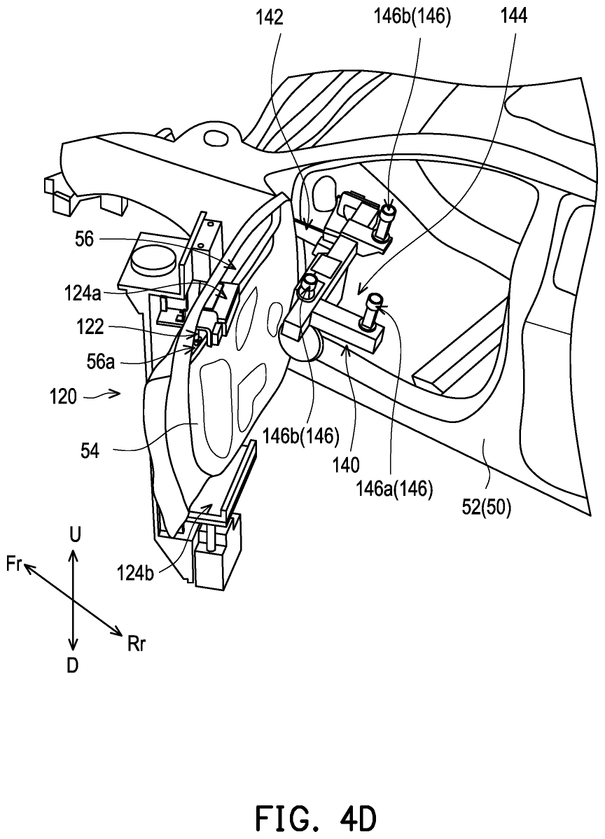

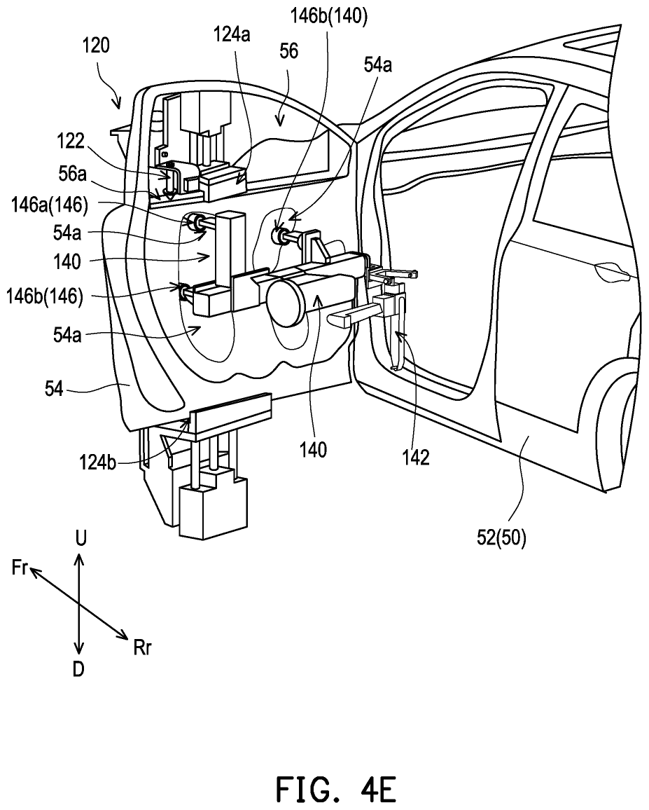

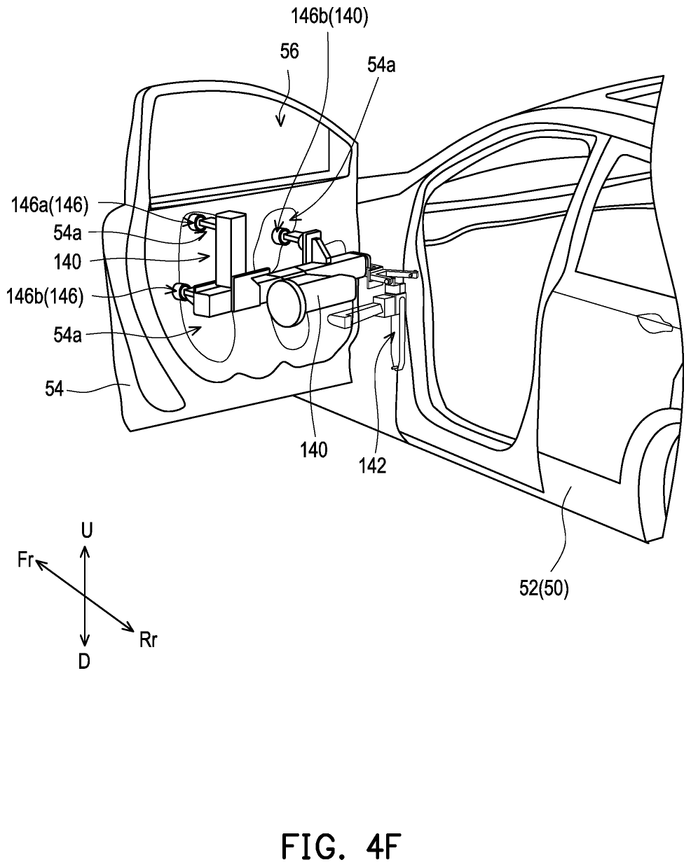

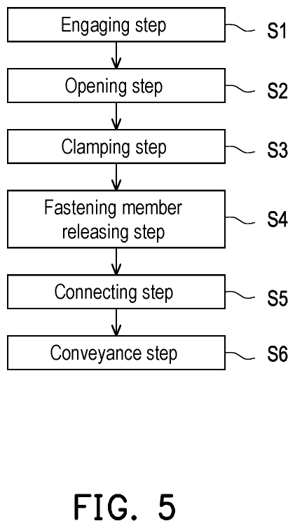

FIG. 4A to FIG. 4F are schematic flowcharts of operations of the vehicle door removal device depicted in FIG. 1 in a vehicle door removal method; FIG. 5 is a schematic flowchart of a vehicle door removal method according to an embodiment of the disclosure. The specific structure of a vehicle door removal device 100 of a vehicle and the specific process of a vehicle door removal method provided in this embodiment are described below with reference to FIG. 1 to FIG. 5. Here, a front-and-back direction of the vehicle is, for instance, a forward direction Fr of the vehicle and a backward direction Rr of the vehicle in the accompanying drawings, and an up-and-down direction of the vehicle is, for instance, an upward direction U of the vehicle and a downward direction D of the vehicle D in the accompanying drawings, which is provided as an exemplary embodiment and should not be construed as limitations in the disclosure.

With reference to FIG. 1, in this embodiment, the vehicle door removal device 100 is adapted to remove a vehicle door 54 from a vehicle body 52 of a vehicle 50. Here, the vehicle door 54 refers to a front door and a back door of the vehicle 50, and the vehicle body 52 and the vehicle door 54 of the vehicle 50 are fastened by a fastening member (e.g., a bolt). Therefore, during the operation of the vehicle door removal device 100, the vehicle door removal device 100 opens the vehicle door 54 from the vehicle body 52 in an outward manner and releases the fastening member, so that the vehicle door 54 may be removed from the vehicle body 52. In addition, the vehicle door removal device 100 is, for instance, disposed on a conveyance line L for disassembling the vehicle 50, so as to remove the vehicle doors of a plurality of the vehicles 50 sequentially conveyed to the vicinity of the vehicle door removal device 100 through the conveyance line L, and after the vehicle doors 54 are removed from the vehicle bodies 52, the vehicle bodies 52 are continuously conveyed to the next station through the conveyance line L for other operations.

For instance, in this embodiment, two sets of vehicle door removal devices 100 are disposed around the conveyance line L shown in FIG. 1. After the conveyance via the conveyance line L (e.g., conveying from the backward direction Rr of the vehicle to the forward direction Fr of the vehicle), the first set of vehicle door removal device 100 corresponding to the forward direction Fr of the vehicle removes a back door of the first vehicle 50 (i.e., the vehicle door 54 corresponding to the backward direction Rr of the vehicle), and the second set of vehicle door removal device 100 corresponding to the backward direction Rr of the vehicle removes a front door of the second vehicle 50 (i.e., the vehicle door 54 corresponding to the forward direction Fr of the vehicle). After that, through the conveyance via the conveyance line L, the first set of vehicle door removal device 100 removes a back door of the second vehicle 50, and the second set of vehicle door removal device 100 removes a front door of the third vehicle 50, and so on. As such, the two sets of vehicle door removal devices 100 may be disposed in adjacent regions without interfering with each other. However, the applications of the vehicle door removal device 100 on the conveyance line L (e.g., the quantity, the position, and so on) are not limited in the disclosure and may be adjusted according to actual requirements.

Specifically, in this embodiment, as shown in FIG. 1 to FIG. 3, the vehicle door removal device 100 includes a first robot arm 110, a first jig 120, a second robot arm 130, and a second jig 140. The first robot arm 110 is disposed on an outer side of the vehicle door 54. The first jig 120 is disposed on the first robot arm 110. The second robot arm 130 is disposed near the first robot arm 110, e.g., disposed on one side of the first robot arm 110 corresponding to the backward direction Rr of the vehicle in the front-and-back direction of the vehicle, which should however not be construed as a limitation in the disclosure. The second jig 140 is disposed on the second robot arm 130. The first jig 120 driven by the first robot arm 110 may perform one part of a vehicle door removal motion on the vehicle door 54, and the second jig 140 driven by the second robot arm 130 may perform the other part of the vehicle door removal motion on the vehicle door 54. The first robot arm 110 and the second robot arm 130 may be the robot arms of independent robots (e.g., single-arm robots) respectively disposed on different bases or the two robot arms of a robot (e.g., a double-arm robot) disposed on one base. Here, the first robot arm 110 located on the outer side of the vehicle door 54 in an open state performs the operation of the first jig 120, and the second robot arm 130 on the inner side of the vehicle door 54 in the open state performs the operation of the second jig 140.

To be specific, in this embodiment, preferably, as shown in FIG. 2 and FIG. 4A to FIG. 4C, the first jig 120 has an engaging part 122 for engaging an opening part 56a disposed on a window frame 56 of the vehicle door 54 and a pair of upper and lower clamping parts 124a and 124b for clamping the vehicle door 54 in an up-and-down direction of the vehicle. Here, the engaging part 122 of the first jig 120 is, for instance, an engaging pin, and may be inserted into the opening part 56a on the window frame 56 when the first jig 120 is driven by the first robot arm 110 to approach the outer side of the vehicle door 54, so that the engaging part 122 is engaged with the opening part 56a (as shown in FIG. 4A). As long as the opening part 56a may be connected to the engaging part 122, the structure of the opening part 56a may be a through hole, a slot, or a step lowered in an inward manner. In an embodiment of the disclosure, the engaging part 122 is engaged with the opening part 56a and connected to the vehicle door 54 when the vehicle door 54 is in a closed state, so that the vehicle door 54 may be opened in an outward manner after being driven by the first robot arm 110 in a subsequent step (as shown in FIG. 4B).

Besides, in this embodiment, the pair of upper and lower clamping parts 124a and 124b of the first jig 120 are, for instance, engaging clamps which may be moved up and down; after the engaging part 122 of the first jig 120 is engaged with the opening part 56a, the engaging clamps may move up and down in opposite directions and abut against upper and lower edges of the vehicle door 54, thereby clamping the vehicle door 54 in an up-and-down direction of the vehicle (as shown in FIG. 4C). In an embodiment of the disclosure, the pair of upper and lower clamping parts 124a and 124b clamps the upper and lower edges of the vehicle door 54 from the outer side of the vehicle door 54 when the vehicle door 54 is in an open state, so as to fix the vehicle door 54. As such, the first robot arm 110 located on the outer side of the vehicle door 54 in the open state performs the operation of the first jig 120.

Moreover, in this embodiment as shown in FIG. 2, the engaging part 122 of the first jig 120 is disposed on the upper clamping part (i.e., the clamping part 124a) of the pair of upper and lower clamping parts 124a and 124b and located on a portion of the upper clamping part (i.e., the clamping part 124a) close to the backward direction Rr of the vehicle (e.g., disposed at a back end of an inner surface of the engaging clamp acting as the clamping part 124a). Thereby, after the engaging part 122 of the first jig 120 is engaged with the opening part 56a and driven by the first robot arm 110 to open the vehicle door 54 in an outward manner, the pair of upper and lower clamping parts 124a and 124b may quickly perform the clamping operation. That is, the engaging operation, the opening operation, and the clamping operation shown in FIG. 4A to FIG. 4C may be performed rapidly and continuously, thereby improving the smoothness of the vehicle door removal motion and reducing the labor hours spent on the vehicle door removal motion. However, the specific structures and the relative positions of the engaging part 122 and the pair of upper and lower clamping parts 124a and 124b are not limited in the disclosure and may be adjusted according to actual requirements.

Correspondingly, in this embodiment, as shown in FIG. 3 and FIG. 4D to FIG. 4F, the second jig 140 has a fastening member releasing part 142 for releasing a fastening member (not shown) fastened on the vehicle body 52 and the vehicle door 54 and a connecting part 144 for connecting the inner side of the vehicle door 54. Here, the fastening member releasing part 142 of the second jig 140 is, for instance, a drill bit which may abut against the fastening member when the second jig 140 is driven by the second robot arm 130 and approaches the inner side of the vehicle door 54, thereby releasing the fastening member fastened on the vehicle body 52 and the vehicle door 54 (as shown in FIG. 4D). In an embodiment of the disclosure, the fastening member releasing part 142 abuts against the fastening member from the inner side of the vehicle door 54 when the vehicle door 54 is in an open state, so as to release the fastening member. In addition, the fastening member releasing part 142 performs the operation of releasing the fastening member when the vehicle door 54 is clamped by the pair of upper and lower clamping parts 124a and 124b of the first jig 120, so that the fastening member may be stably released on the condition that the vehicle door 54 is fixed.

Additionally, in this embodiment, the connecting part 144 of the second jig 140 includes a plurality of protruding parts 146. After the fastening member releasing part 142 of the second jig 140 releases the fastening member, the connecting part 144 of the second jig 140 connects the inner side of the vehicle door 54 by inserting the protruding parts 146 into a plurality of opening parts 54a disposed on the inner side of the vehicle door 54 (as shown in FIG. 4E). As long as the opening parts 54a may be connected to the protruding parts 146 acting as the connecting part 144, the structure of the opening parts 54a may be through holes, slots, or steps lowered in an inward manner. In an embodiment of the disclosure, the connecting part 144 connects the inner side of the vehicle door 54 after the fastening member is released (i.e., when the vehicle door 54 no longer connects the vehicle body 52), so that the connecting part 144 may be driven by the second robot arm 130 in the subsequent step and may convey the removed vehicle door (as shown in FIG. 4F). As such, the second robot arm 130 located on the inner side of the vehicle door 54 in an open state performs the operation of the second jig 140.

Moreover, in this embodiment as shown in FIG. 3, the fastening member releasing part 142 of the second jig 140 and the protruding parts 146 acting as the connecting part 144 are disposed on different end surfaces of the second jig 140, and the protruding parts 146 acting as the connecting part 144 are disposed on the same end surface of the second jig 140. Thereby, when the fastening member releasing part 142 of the second jig 140 performs the fastening member releasing operation, the second jig 140 is rotated to enable the fastening member releasing part 142 to face the fastening member between the vehicle body 52 and the vehicle door 54 and enable the protruding parts 146 acting as the connecting part 144 to face the upward direction U of the vehicle (as shown in FIG. 4D), and thus the protruding parts 146 acting as the connecting part 144 do not interfere with the operation of the fastening member releasing part 142. Correspondingly, when the connecting part 144 of the second jig 140 performs the connecting operation, the second jig 140 is rotated to enable the protruding parts 146 acting as the connecting part 144 to face the opening parts 54a disposed on the inner side of the vehicle door 54 and enable the fastening member releasing part 142 to face the downward direction D of the vehicle (as shown in FIG. 4E), and thus the fastening member releasing part 142 does not interfere with the operation of the protruding parts 146 acting as the connecting part 144.

Besides, in this embodiment, as shown in FIG. 3, the protruding parts 146 of the second jig 140 acting as the connecting part 144 include at least one fixed protruding part 146a (e.g., one) and at least one movable protruding part 146b (e.g., two). The movable protruding parts 146b move relative to the fixed protruding part 146a to adjust a distance between the movable protruding parts 146b and the fixed protruding part 146a. For instance, the second jig 140 is driven by the second robot arm 130 to move to the positions where the protruding parts 146 respectively penetrate the opening parts 54a (as shown in FIG. 4E). At this time, in an embodiment of the disclosure, the second robot arm 130 is moved, so that the fixed protruding part 146a (e.g., a fixed roller) abuts against a side edge of the corresponding opening part 54a. Thereafter, in response to the positions of the opening parts 54a disposed on the vehicle doors 54 of different models, the movable protruding parts 146b (e.g., movable rollers) are driven by a driving source (not shown, e.g., a cylinder) to slightly adjust their positions to abut against the side edges of the corresponding opening parts 54a. In an embodiment of the disclosure, the protruding parts 146 exert forces to the inner side of the vehicle door 54 in different directions. For instance, one fixed protruding part 146a in FIG. 4E exerts a force substantially to the upward direction U of the vehicle, and the two movable protruding parts 146b exert a force roughly in opposite left and right directions, so as to connect the inner side of the vehicle door 54 more firmly. However, the specific structures and the relative positions of the fastening member releasing part 142, the connecting part 144, and the protruding parts 146 are not limited in the disclosure and may be adjusted according to actual requirements.

In addition, according to this embodiment, as shown in FIG. 4A to FIG. 4F and FIG. 5, the vehicle door removal method is adapted to remove the vehicle door 54 from the vehicle body 52 of the vehicle 50. The vehicle door removal method includes an engaging step S1, an opening step S2, a clamping step S3, a fastening member releasing step S4, a connecting step S5, and a conveyance step S6. That is, the vehicle door removal method is suitable for performing the vehicle door removal motion by applying the vehicle door removal device 100, which should however not be construed as a limitation in the disclosure.

Specifically, according to this embodiment, in the engaging step S1 as shown in FIG. 4A, the engaging part 122 of the first jig 120 disposed on the first robot arm 110 is engaged with the opening part 56a on the window frame 56 of the vehicle door 54. Next, in the opening step S2 as shown in FIG. 4B, the first robot arm 110 moves relative to the vehicle body 52 to open the vehicle door 54 in an outward manner. After that, in the clamping step S3 as shown in FIG. 4C, the pair of upper and lower clamping parts 124a and 124b of the first jig 120 disposed on the first robot arm 110 is moved up and down to clamp the vehicle door 54 in an up-and-down direction of the vehicle. Thereby, the first robot arm 110 located on the outer side of the vehicle door 54 in an open state performs the operation of the first jig 120.

Next, according to this embodiment, in the fastening member releasing step S4 as shown in FIG. 4D, the fastening member releasing part 142 of the second jig 140 disposed on the second robot arm 130 releases the fastening member fastened on the vehicle body 52 and the vehicle door 54. After that, in the connecting step S5 as shown in FIG. 4E, the inner side of the vehicle door 54 is connected by the connecting part 144 of the second jig 140 disposed on the second robot arm 130. According to an embodiment of the disclosure, in the connecting step S5, the connecting part 144 of the second jig 140 connects the inner side of the vehicle door 54 by inserting the protruding parts 146 respectively into the opening parts 54a disposed on the inner side of the vehicle door 54 (as shown in FIG. 4E). As such, in the connecting step S5, the movable protruding parts 146b move relative to the fixed protruding part 146a to adjust the distance between the movable protruding parts 146b and the fixed protruding part 146a. Finally, in the conveyance step S6 as shown in FIG. 4F, the second robot arm 130 moves relative to the vehicle body 52 in an outward manner and conveys the vehicle door 54 in an outward manner. According to an embodiment of the disclosure, in the connecting step S5, after the inner side of the vehicle door 54 is connected by the connecting part 144 of the second jig 140, the pair of upper and lower clamping parts 124a and 124b of the first jig 120 is released, and the conveyance step S6 is performed on the condition that only the connecting part 144 of the second jig 140 connects the vehicle door 54. Thereby, the second robot arm 130 located on the inner side of the vehicle door 54 in an open state performs the operation of the second jig 140.

According to the above descriptions, in the vehicle door removal device 100 and the vehicle door removal method, the engaging part 122 of the first jig 120 disposed on the first robot arm 110 is engaged with the opening part 56a on the window frame 56 of the vehicle door 54, so as to open the vehicle door 54 in an outward manner. The pair of upper and lower clamping parts 124a and 124b of the first jig 120 clamps the vehicle door 54 in an up-and-down direction of the vehicle. The fastening member releasing part 142 of the second jig 140 disposed on the second robot arm 130 releases the fastening member fastened on the vehicle body 52 and the vehicle door 54. The connecting part 144 of the second jig 140 connects the inner side of the vehicle door 54 to convey the vehicle door 54 in an outward manner. Thereby, the first robot arm 110 located on the outer side of the vehicle door 54 in an open state performs the operation of the first jig 120, and the second robot arm 130 located on the inner side of the vehicle door 54 in the open state performs the operation of the second jig 140. Accordingly, the vehicle door removal device 100 and the vehicle door removal method may prevent the moving traces of the robot arms from interfering with each other, thereby improving the degree of freedom of the motion of removing the vehicle door. However, the vehicle door removal device 100 and the vehicle door removal method described above are provided as an exemplary embodiment, and the specific structure of the vehicle door removal device 100 and the specific process of the vehicle door removal method may be adjusted according to actual requirements and should not be construed as limitations in the disclosure.

To sum up, in the vehicle door removal device and the vehicle door removal method provided in one or more embodiments of the disclosure, the engaging part of the first jig disposed on the first robot arm is engaged with the opening part on the window frame of the vehicle door to open the vehicle door in an outward manner, the pair of upper and lower clamping parts of the first jig clamps the vehicle door in an up-and-down direction of the vehicle, the fastening member releasing part of the second jig disposed on the second robot arm releases the fastening member fastened on the vehicle body and the vehicle door, and the connecting part of the second jig connects the inner side of the vehicle door to convey the vehicle door in an outward manner. According to an embodiment of the disclosure, the connecting part of the second jig includes the protruding parts, and the connecting part of the second jig connects the inner side of the vehicle door by inserting the protruding parts respectively into the opening parts disposed on the inner side of the vehicle door. As such, the first robot arm located on the outer side of the vehicle door in an open state performs the operation of the first jig, and the second robot arm located on the inner side of the vehicle door in the open state performs the operation of the second jig. Accordingly, the disclosure's door removal device and vehicle door removal method can avoid a plurality of robot arm moving traces from interfering with each other, thereby improving the degree of freedom of the motion of removing the vehicle door.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle door removal device, adapted to remove a vehicle door from a vehicle body of a vehicle and comprising:
a first robot arm, disposed on an outer side of the vehicle door;
a first jig, disposed on the first robot arm and having an engaging part for engaging an opening part on a window frame of the vehicle and a pair of upper and lower clamping parts for clamping the vehicle door in an up-and-down direction of the vehicle;
a second robot arm, disposed near the first robot arm; and
a second jig, disposed on the second robot arm and having a fastening member releasing part for releasing a fastening member fastened on the vehicle body and the vehicle door and a connecting part for connecting an inner side of the vehicle door, wherein the first robot arm located on the outer side of the vehicle door in an open state performs an operation of the first jig, and the second robot arm located on the inner side of the vehicle door in the open state performs an operation of the second jig.

2. The vehicle door removal device according to claim 1, wherein the engaging part of the first jig is disposed on the upper clamping part of the pair of upper and lower clamping parts and located on a portion of the upper clamping part close to a backward direction of the vehicle.

3. The vehicle door removal device according to claim 1, wherein the connecting part of the second jig comprises a plurality of protruding parts, and the connecting part of the second jig connects the inner side of the vehicle door by inserting the plurality of protruding parts respectively into a plurality of opening parts disposed on the inner side of the vehicle door.

4. The vehicle door removal device according to claim 3, wherein,
the plurality of protruding parts comprise at least one fixed protruding part and at least one movable protruding part, and
the at least movable protruding part moves relative to the at least one fixed protruding part to adjust a distance between the at least one movable protruding part and the at least one fixed protruding part.

5. A vehicle door removal method, adapted to remove a vehicle door from a vehicle body of a vehicle and comprising:
an engaging step of engaging an opening part on a window frame of the vehicle door through an engaging part of a first jig disposed on a first robot arm:
an opening step of opening the vehicle door in an outward manner through the first robot arm which moves relative to the vehicle body;
a clamping step of clamping the vehicle door in an up-and-down direction of the vehicle by moving a pair of upper and lower clamping parts of the first jig disposed on the first robot arm up and down;
a fastening member releasing step of releasing a fastening member fastened on the vehicle body and the vehicle door through a fastening member releasing part of a second jig disposed on a second robot arm;
a connecting step of connecting an inner side of the vehicle door through a connecting part of the second jig disposed on the second robot arm; and
a conveyance step of conveying the vehicle door in an outward manner through the second robot arm moving in an outward manner relative to the vehicle body, wherein
the first robot arm located on an outer side of the vehicle door in an open state performs an operation of the first jig, and the second robot arm located on the inner side of the vehicle door in the open state performs an operation of the second jig.

6. The vehicle door removal method according to claim 5, wherein,
after the connecting part of the second jig connects the inner side of the vehicle door in the connecting step, releasing the pair of the upper and lower clamping parts of the first jig and performing the conveyance step on a condition that the connecting part of the second jig connects the vehicle door.

7. The vehicle door removal method according to claim 5, wherein,
the connecting part of the second jig comprises a plurality of protruding parts, and
in the connecting step, the connecting part of the second jig connects the inner side of the vehicle door by inserting the plurality of protruding parts respectively into a plurality of opening parts disposed on the inner side of the vehicle door.

8. The vehicle door removal method according to claim 7, wherein,
the plurality of protruding parts comprise at least one fixed protruding part and at least one movable protruding part, and
in the connecting step, the at least one movable protruding part moves relative to the at least one fixed protruding part to adjust a distance between the at least one movable protruding part and the at least one fixed protruding part.
